(19) United States
(12) Patent Application Publication
(10) Pub. No.: US 2026/0169180 A1
(43) Pub. Date: Jun. 18, 2026

(54) SYSTEMS AND METHODS FOR EARTHQUAKE DETECTION USING DATA FUSION

(71) Applicant: Idan Roth, Adanim (IL)

(72) Inventors: Idan Roth, Adanim (IL); Sarel Cohen, Tel-Aviv (IL); Ittai Kurzon, Binyamina (IL)

(73) Assignee: Idan Roth, Adanim (IL)

(21) Appl. No.: 19/416,778

(22) Filed: Dec. 11, 2025

Related U.S. Application Data
(60) Provisional application No. 63/733,164, filed on Dec. 12, 2024.

(51) Int. Cl. G01V 1/01; G01V 1/00; G01V 1/28; G01V 1/30

(52) U.S. Cl. CPC G01V 1/01; G01V 1/282; G01V 1/30; G01V 1/003

(57) ABSTRACT

A system for seismic event prediction uses seismic sensors and non-seismic sensors to collect real-time data at one or more sites. One or more processors receive the data, align it into time-synchronized windows, and generate modality-specific features. The system executes at least one predictive pathway selected from: a seismic model trained on seismic features, a non-seismic model trained on non-seismic features, a feature-fusion model trained on a joint representation of both, and a decision-fusion model that combines outputs of the seismic and non-seismic models. The system produces a model output indicating a likelihood of a seismic event within a prediction horizon and, in some cases, a magnitude estimate or time window, and generates an alert based on the output using region-configurable thresholds.

### CROSS REFERENCE TO RELATED APPLICATIONS

This application claims the benefit of U.S. Provisional Application No. 63/733,164, filed Dec. 12, 2024, entitled “Systems and Methods for Early Earthquake Detection,” which is incorporated by reference herein in its entirety under 35 U.S.C. § 119(e).

### FIELD OF THE TECHNOLOGY

This disclosure relates to multi-modal sensing and machine learning for natural hazard early warning. More specifically, it concerns systems and methods for predicting earthquakes by fusing seismic data with non-seismic signals, including animal-behavior telemetry aggregated at pasture and regional levels, and by implementing both fusion and non-fusion analysis tracks to generate calibrated, region-specific alerts.

### BACKGROUND

In national earthquake disaster scenarios, thousands of lives may be at risk, with their fate often dependent on the speed of rescue. Past events highlight that post-event rescuing activities have a limited effect. For example, the Dead-Sea Fault is a left-lateral strike-slip fault, with an occurrence rate of a Mw 6 earthquake per 100 years; the last one, the 1927 M 6.25 on the Jericho segment, caused huge regional devastation with more than 300 casualties. The impact of advance notice of these earthquakes on life-saving measures cannot be understated.

### SUMMARY

Disclosed are systems and methods that collect and process data from seismic sensors and non-seismic animal-behavior telemetry, including daily and sub-daily (e.g., 15-minute) records, aligned to common time windows. The systems implement seismic-only models, non-seismic-only models, feature-level fusion models, and late-fusion ensembles. A spatio-temporal super model is trained using data from multiple sites and combined with site-specific and per-sensor models to account for local conditions. Model outputs are aggregated via triangulation, statistical methods, and learned aggregation to produce regional predictions of earthquake likelihood, magnitude, and timing.

An alert decision module applies calibrated, region-specific thresholds, dynamic base-rate adjustments, and hysteresis, issuing alerts when confidence thresholds are met.

The disclosed architecture is robust to sensor dropout and supports fallback modes wherein seismic-only or non-seismic-only inference can continue during partial network outages. Case studies indicate earlier anomaly detection windows relative to seismic-only baselines, with empirical observations demonstrating potential lead times on the order of hours.

In some aspects, the techniques described herein relate to a system for seismic event prediction, including: one or more seismic sensors configured to collect real-time seismic data at one or more sites; one or more non-seismic sensors configured to collect real-time non-seismic data at the one or more sites; and one or more processors and memory storing instructions that, when executed by the one or more processors, cause the system to: receive the real-time seismic data and the real-time non-seismic data from the one or more sites; generate modality-specific features from the real-time seismic data and the real-time non-seismic data over time-synchronized windows; execute at least one predictive model selected from: a seismic model trained on the modality-specific features from the real-time seismic data, a non-seismic model trained on the modality-specific features from the real-time non-seismic data, a feature-fusion model trained on a joint representation of the modality-specific features from the real-time seismic data and the real-time non-seismic data, and a decision-fusion model configured to combine outputs of the seismic model and the non-seismic model; produce a model output indicative of a likelihood of a seismic event within a prediction horizon; and generate an alert based on the model output according to a threshold that is configurable per geographic region.

In some aspects, the techniques described herein relate to a system, wherein the one or more non-seismic sensors include animal-wearable devices configured to capture behavioral telemetry and wherein the modality-specific features from the real-time non-seismic data include activity measures, rest measures, or motion-frequency variance derived from accelerometry.

In some aspects, the techniques described herein relate to a system, wherein the one or more sites include a plurality of pastures and the one or more processors are further configured to aggregate per-animal or per-device predictions to produce per-pasture predictions and to combine the per-pasture predictions into a regional prediction.

In some aspects, the techniques described herein relate to a system, wherein the one or more processors are further configured to train a spatio-temporal super model using historical seismic data and historical non-seismic data collected from the one or more sites and to adapt the spatio-temporal super model to a particular site using site-specific data.

In some aspects, the techniques described herein relate to a system, wherein the one or more processors are further configured to obtain site-specific predictions from site-specific models and to combine the site-specific predictions using at least one of triangulation, statistical aggregation, or a learned aggregation model to produce the model output.

In some aspects, the techniques described herein relate to a system, wherein the one or more processors are further configured to calibrate the model output to a probability using calibration data and to set the threshold based on a seismicity baseline of a geographic region.

In some aspects, the techniques described herein relate to a system, wherein the one or more processors are further configured to apply hysteresis or persistence criteria to the model output prior to generating the alert.

In some aspects, the techniques described herein relate to a system, wherein the one or more processors are further configured to operate in a seismic-only mode when the real-time non-seismic data are unavailable and to operate in a non-seismic-only mode when the real-time seismic data are unavailable.

In some aspects, the techniques described herein relate to a system, wherein generating the modality-specific features from the real-time seismic data includes computing bandpower features, spectral entropy, short-term-average to long-term-average ratios, or autoregressive coefficients over the time-synchronized windows.

In some aspects, the techniques described herein relate to a system, wherein generating the modality-specific features from the real-time non-seismic data includes extracting statistical features, spectral features, temporal features, or change-point indicators over the time-synchronized windows.

In some aspects, the techniques described herein relate to a method for seismic event prediction, including: receiving real-time seismic data and real-time non-seismic data from one or more sensors at one or more sites; generating modality-specific features from the real-time seismic data and the real-time non-seismic data over time-synchronized windows; executing at least one predictive model selected from: a seismic model trained on the modality-specific features from the real-time seismic data, a non-seismic model trained on the modality-specific features from the real-time non-seismic data, a feature-fusion model trained on a joint representation of the modality-specific features from the real-time seismic data and the real-time non-seismic data, and a decision-fusion model configured to combine outputs of the seismic model and the non-seismic model; producing a model output indicative of a likelihood of a seismic event within a prediction horizon; and generating an alert based on the model output according to a threshold that is configurable per geographic region.

In some aspects, the techniques described herein relate to a method, wherein the real-time non-seismic data include behavioral telemetry captured by animal-wearable devices and wherein generating the modality-specific features from the real-time non-seismic data includes extracting activity measures, rest measures, or motion-frequency variance derived from accelerometry.

In some aspects, the techniques described herein relate to a method, wherein the one or more sites include a plurality of pastures and further including aggregating per-animal or per-device predictions to produce per-pasture predictions and combining the per-pasture predictions into a regional prediction.

In some aspects, the techniques described herein relate to a method, further including training a spatio-temporal super model using historical seismic data and historical non-seismic data collected from the one or more sites and adapting the spatio-temporal super model to a particular site using site-specific data.

In some aspects, the techniques described herein relate to a method, further including obtaining site-specific predictions from site-specific models and combining the site-specific predictions using at least one of triangulation, statistical aggregation, or a learned aggregation model to produce the model output.

In some aspects, the techniques described herein relate to a method, further including calibrating the model output to a probability using calibration data and setting the threshold based on a seismicity baseline of a geographic region.

In some aspects, the techniques described herein relate to a method, further including localizing an epicentral zone based on spatial consistency of the per-pasture predictions.

In some aspects, the techniques described herein relate to a method, further including selecting a predictive model based on sensor availability or data quality metrics associated with the real-time seismic data or the real-time non-seismic data.

In some aspects, the techniques described herein relate to a method, wherein the prediction horizon is a lead-time window within a range from minutes to days.

In some aspects, the techniques described herein relate to an apparatus for seismic event prediction, including: a processor; a memory coupled to the processor; at least one seismic sensor interface configured to receive seismic data; at least one non-seismic sensor interface configured to receive non-seismic data; and instructions stored in the memory that, when executed by the processor, cause the apparatus to: time-align the seismic data and the non-seismic data into windows; compute features from the windows; apply a predictive model to the features to generate a score indicative of a seismic event within a lead-time window; and compare the score to a threshold to produce an alert.

### DESCRIPTION OF THE DRAWINGS

Reference is made to the following detailed description taken in conjunction with the accompanying drawings in which:

FIG. 1 is system overview in which seismic data is collected, analyzed, and processed to provide alerts regarding earthquakes.

FIG. 2 includes a system overview regarding training of a spatio-temporal super-model of FIG. 1.

FIG. 3 includes a system overview regarding training of a spatio-temporal model of FIG. 1 per-site.

FIG. 4 includes a system overview regarding training of a separate data type model of FIG. 1 per-site.

FIG. 5 includes a system overview regarding training of a separate data type model of FIG. 1 per-sensor.

FIG. 6 includes a process overview of a method of training a supervised machine learning model on time-series data.

FIG. 7 includes a block diagram of an example computing device configured to implement functionalities of the present disclosure.

FIG. 8 includes a flowchart of an example of a method for seismic event prediction according to the present disclosure.

FIG. 9 includes a graph of an example illustrating seismic event prediction according to the present disclosure

### DETAILED DESCRIPTION

The prediction and early warning of earthquakes face entrenched challenges arising from Earth-system complexity and practical limits of sensing infrastructure. Seismological networks primarily observe ground motion at discrete points and infer subsurface processes indirectly, constraining real-time visibility into stress evolution across broad regions. Sparse station coverage, heterogeneous instrumentation, and environmental noise degrade interpretation fidelity, especially where network density is limited. Data from different sources arrive at differing cadences and with inconsistent quality controls, complicating synchronization and reducing confidence in any single indicator. Many candidate precursory phenomena are weak, intermittent, or confounded by non-tectonic factors, making it difficult to separate meaningful patterns from background variability. Even where useful indicators exist, operationalization requires scalable processing pipelines, robust labeling against ground-truth catalogs, and decision frameworks that yield actionable alerts without overwhelming end users with false positives.

The aspiration to forecast earthquakes is natural and understandable, but achieving it is far more complex. Unlike the atmosphere, the solid Earth is largely hidden from direct observation and is monitored mainly by seismometers that record ground motion. Subsurface imaging in real time would require extremely dense sensor coverage and very high-throughput processing. Stresses, the key quantities governing failure, cannot be measured directly; instruments measure strain at discrete points, which can only be converted to stress under simplifying mechanical assumptions. A reliable, real-time picture of the evolving stress field around seismotectonic sources is still beyond current capabilities.

Prediction and earthquake early warning (EEW) address different problems. Prediction seeks actionable notice before nucleation, ideally minutes to hours or longer in advance. EEW, in contrast, begins after an event has already initiated, using the higher speed of telecommunications to overtake the seismic waves and alert the public ahead of the arrival of the damaging waves. Lead time is therefore limited—typically seconds to tens of seconds—and there is a blind zone near the source where alerts arrive too late. EEW supports rapid protective actions, but it does not replace true prediction.

Such limits motivate additional monitoring approaches. Statistical analyses of seismic catalogs aim to identify repeatable precursory patterns. Geodetic measurements such as continuous GPS and InSAR seek surface deformation that may reflect subsurface loading. Other non-seismic observations, including physical, biological, geophysical, and geochemical signals, have been reported before some earthquakes. However, many claimed precursors lack consistent, quantitative definitions and a well-established physical mechanism linking observed anomalies to the evolving tectonic stress state.

In view of these constraints, the present disclosure includes a data-driven approach that unifies seismic measurements with independently collected non-seismic observations, such as biological, environmental, infrastructure, electromagnetic, geochemical, GNSS, satellite remote sensing, and power-grid or communications-network telemetry, to enhance the timeliness and reliability of earthquake prediction. By aligning heterogeneous time-series streams and learning spatio-temporal patterns across multiple sites and resolutions, the present disclosure provides earlier and more stable predictions than approaches that depend on a single data source.

In an aspect, the present disclosure includes acquisition of real-time seismic waveforms alongside non-seismic telemetry that can include biological signals (e.g., animal or human wearables), environmental and infrastructure sensors, imaging or acoustic devices, and other distributed sensor networks, collected across pastures, farms, facilities, transportation corridors, and urban or rural sites. It further includes synchronized windowing of these streams and extraction of modality-specific and cross-modal features—including statistical, spectral, temporal, spatial, graph-based, and event-driven descriptors—enabling models to learn relationships that evolve on different time scales. This alignment reduces information loss due to sampling mismatches and improves the comparability of signals across sites. The architecture also includes multiple prediction pathways—seismic-only models, non-seismic-only models, and fusion models at feature, representation, and decision levels—implemented using rule-based, statistical, machine-learning, deep-learning, physics-informed, or hybrid approaches so that operation continues under partial data availability while still leveraging complementary signals when multiple modalities are available. Maintaining distinct pathways provides resilience to sensor outages and allows each pathway to be tuned to its modality's noise profile.

The present disclosure includes a spatio-temporal “super” model or ensemble trained on data aggregated from geographically diverse sites, combined with site-specific and per-sensor models that adapt to local baselines, and optionally trained using transfer learning, meta-learning, or federated learning to accommodate data locality and privacy constraints. This hierarchy captures global regularities while permitting fine-grained adjustment to local conditions, increasing generalization to new regions and reducing calibration drift when local environments or herd compositions change. Aggregation across sites can use triangulation, statistical synthesis, Bayesian fusion, Dempster-Shafer theory, graph-based message passing, Kalman or particle filtering, or learned aggregation, allowing geographically distributed predictions to be reconciled into regional outputs that better reflect spatial coherence in precursory patterns. Incorporating uncertainty-aware aggregation stabilizes predictions when individual sites exhibit transient anomalies.

The present disclosure includes a labeling and evaluation framework that supports binary event likelihood, magnitude ranges, epicentral zone localization, shaking intensity classes, and time-to-event targets across defined lead-time windows, and can employ cost-sensitive and multi-objective optimization or conformal prediction to provide calibrated coverage guarantees. This multi-task structure allows models to exploit shared representations while providing outputs aligned with operational requirements for actionable alerting. The present disclosure further includes calibration procedures that map model scores to well-calibrated probabilities and thresholding policies conditioned on regional seismicity and recent base rates, optionally incorporating risk-aware utility functions and user-or policy-defined operating points, which reduces over-alerting in quiet periods and raises sensitivity when background risk is elevated. The disclosure further includes alert hold-and-verify logic and hysteresis, graded alert levels with escalating confidence requirements, optional multi-stage human-in-the-loop review, and interfaces for automated actuation of mitigation workflows, thereby minimizing oscillation between alert states and reducing operator workload. As a practical demonstration, empirical observations show that non-seismic signals—including behavioral, environmental, and infrastructure telemetry—can exhibit pronounced, isolated anomalies in proximity to subsequent regional earthquakes, illustrating the usefulness of cross-modal signals for extending lead time in real-world settings and across differing deployment contexts.

The present disclosure includes analyzing real-time, quantitative animal-behavior telemetry together with independent estimates of stress and strain proxies derived from seismic and geophysical observations. Detected behavioral anomalies are tested for reproducible correlations with changes in proxy measures inferred from seismology, GPS, or other geophysical data, including analysis of their dependence on event magnitude and source distance. The present disclosure includes windowed synchronization, feature extraction, and labeling that enable joint, rigorously quantified evaluation of behavioral signals relative to strain/stress proxies. By relating animal-behavior observations to plausible mechanisms associated with crustal changes—while avoiding any requirement for direct stress-field recovery—the present disclosure provides potential predictive indicators that can be incorporated into model training, calibration, aggregation, and alert decision-making.

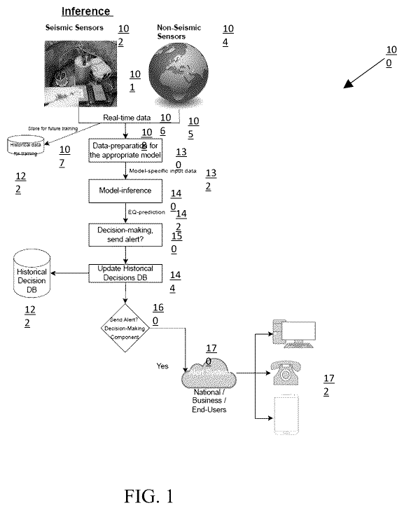

Referring to FIG. 1, an inference and alert-generation process 100 is shown in which heterogeneous sensor data and historical decision information are processed to predict seismic events according to the present disclosure. According to an implementation, real-time data 106 are acquired from seismic sensors 102 and non-seismic sensors 104 deployed at one or more sites 101, locally or globally. The real-time data 106 are conveyed over a data path 108 into a data-preparation component 130 that formats incoming measurements and generates model-specific input data 132 for a selected predictive pathway. The prepared data 132 are processed by a model-inference module 140 to produce an earthquake-prediction result 142. A decision-making component 150 evaluates the earthquake-prediction result 142 and writes the decision outcome at block 144 to a historical decisions database 122 to enable continual refinement of decision logic. A decision branch 160 determines whether an alert should be transmitted. When transmission is warranted, an alert system 170 disseminates notifications to designated government and business recipients and to terminal devices and end instruments 172, including computer terminals, landline telephones, and smartphones.

According to an example implementation, at step 105, the method 100 includes acquiring real-time data 106 from the seismic sensors 102 and the non-seismic sensors 104 at one or more sites 101. This function can be performed by an ingest subsystem of a device or a networked computing environment that includes one or more processors, memory, and sensor interfaces configured to accept continuous data streams from the sensors 102, 104. In a broad aspect, acquiring the real-time data 106 at step 105 includes continuously collecting seismic waveforms and contemporaneous non-seismic telemetry across multiple geographic regions to provide comprehensive situational awareness and to support both local and regional analysis. At the same time or alternatively, real-time data 106 may be conveyed at step 107 to database 122. In an example, this real-time data 106 may be used for training one or more models associated with process 100.

At step 108, the method 100 includes conveying the real-time data 106 over the data path 108 to the data-preparation component 130. This operation can be implemented by network interfaces and message-queue transport executed by a processor that routes the measurements to downstream processing. In a broad aspect, conveying the data along the data path 108 ensures ordered, loss-aware delivery of multi-modal streams so that subsequent processing stages operate on complete, time-consistent inputs.

At block 130, the method 100 includes preparing the real-time data 106 to generate model-specific input data 132 appropriate for a selected predictive model. This function can be performed by the data-preparation component 130 executing on one or more processors that perform formatting, normalization, synchronization, and feature assembly. In a broad aspect, preparing the data produces modality-appropriate and time-aligned inputs so that different classes of models can operate effectively on heterogeneous sources without loss of temporal correspondence.

At block 140, the method 100 includes performing model-based inference to output an earthquake-prediction result 142. This function can be performed by the model-inference module 140, which executes a selected predictive model on the model-specific input data 132 to produce a result such as a likelihood, a category, or another quantitative prediction. In a broad aspect, performing model-based inference transforms the prepared inputs into interpretable outputs that quantify near-term seismic risk, enabling subsequent decision logic to act on calibrated signals rather than raw measurements.

At block 150, the method 100 includes evaluating the earthquake-prediction result 142 to determine whether to issue an alert and updating the historical decisions database 122. This function can be performed by the decision-making component 150, which applies decision criteria to the result 142 and records the decision outcome and context to the database 122 at block 144. In a broad aspect, evaluating the prediction and updating the database 122 provide a feedback loop that supports continuous improvement of future decision thresholds, policies, or model selection strategies using accumulated operational history.

At block 160, the method 100 includes branching the workflow based on the decision outcome. This operation can be performed by a decision branch 160 implemented in software that conditionally activates downstream alerting. In a broad aspect, branching at 160 ensures alerts are transmitted only when decision criteria are satisfied, reducing unnecessary notifications while preserving responsiveness to elevated risk.

At block 170, the method 100 includes disseminating an alert when the decision branch 160 indicates that transmission is warranted. This function can be performed by the alert system 170, which interfaces with public-alerting infrastructure for government stakeholders and enterprise systems for business stakeholders, and which communicates with terminal devices and end instruments 172, including computer terminals, landline telephones, and smartphones. In a broad aspect, disseminating alerts provides timely, targeted notification across available channels so that recipients can take protective or operational actions consistent with their roles and the predicted event context.

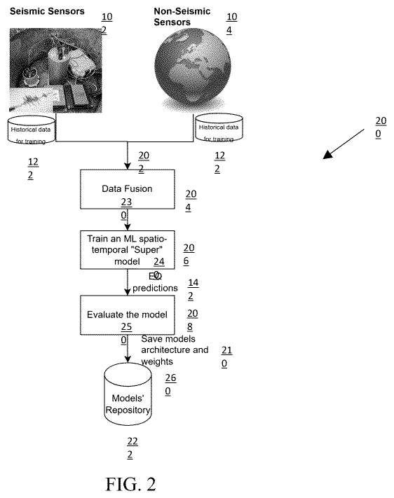

Referring to FIG. 2, a training process 200 is shown that complements the inference and alert-generation process 100 by generating and maintaining machine-learning models for seismic-event prediction according to the present disclosure. In an example implementation, historical datasets derived from seismic sensors 102 and non-seismic sensors 104 are aggregated and fused to form unified training inputs. A training module then learns a spatio-temporal “super” model capable of producing earthquake-prediction outputs across regions and time scales. The trained model undergoes evaluation, and, upon satisfactory performance, the model architecture and learned weights are stored in a models'repository 222 for deployment to the real-time pipeline of FIG. 1, as well as for version control, comparative analysis, and scheduled or event-driven retraining.

According to an example implementation, at step 202, the method 200 includes aggregating historical data collected from seismic sensors 102 and non-seismic sensors 104. This function can be performed by a data-ingest and curation subsystem executing on one or more processors that retrieve time-stamped measurements, metadata, and labels from storage systems associated with the sites 101 and the historical decisions database 122 described in FIG. 1. In a broad aspect, aggregating historical data consolidates heterogeneous records, including waveforms, telemetry, quality indicators, and ground-truth labels, into a consistent schema to enable downstream fusion and training. For example, this may be performed to ensure that the training corpus captures representative variability across geography, seasonality, instrumentation, and operating conditions.

At block 204, the method 200 includes fusing the aggregated historical datasets using a data fusion component 230 to form a unified training set. This function can be performed by the data fusion component 230, which runs on one or more processors to align timestamps, normalize units, handle missingness, and construct synchronized examples that combine seismic and non-seismic measurements. In a broad aspect, fusing historical datasets produces modality-consistent, time-aligned inputs so that models can learn cross-modal dependencies and spatio-temporal patterns. For example, this may be performed to reduce information loss due to differing cadences and to expose relationships that emerge only when modalities are considered jointly.

At block 206, the method 200 includes training a machine-learning spatio-temporal “super” model using the unified training set. This function can be performed by a training module 240, which executes on processors and accelerators to optimize model parameters with respect to prediction targets using the fused inputs and any site or region metadata. In a broad aspect, training the spatio-temporal super model learns representations that generalize across sites 101 and time periods while still capturing local structure when available. For example, this may be performed to support deployment in monitored regions and adaptation to new or sparsely instrumented areas using shared patterns learned from diverse historical data. As shown in FIG. 2, this may include outputting an earthquake-prediction result 142, which may be used to evaluate the trained model.

At block 208, the method 200 includes evaluating the trained model to assess prediction quality and performance metrics. This function can be performed by an evaluation component 250 that executes validation protocols, such as temporally separated validation, geographically separated validation, and calibration checks, on held-out historical data. In a broad aspect, evaluating the trained model quantifies discrimination, calibration, lead-time characteristics, and stability under distributional shifts. For example, this may be performed to verify suitability for operational use in the process 100 and to identify whether further training, tuning, or data curation is required.

At block 210, the method 200 includes storing a model architecture and corresponding learned weights in a models'repository 222. This function can be performed by a model registry service 260 that persists model artifacts, training metadata, and version identifiers to storage, enabling controlled deployment to the inference pipeline of FIG. 1 and facilitating future retraining and comparative analysis among model versions. In a broad aspect, storing the model architecture and weights with associated provenance ensures reproducibility, auditability, and coordinated rollout. For example, this may be performed to maintain a reliable catalog of deployable models, to support rollback if needed, and to streamline periodic retraining as new historical data and decision outcomes become available.

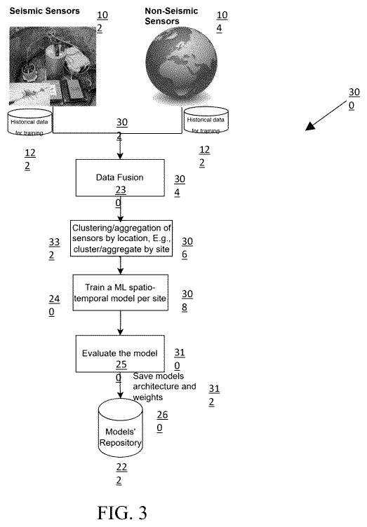

Referring to FIG. 3, a process 300 is shown for training multiple site-specific machine-learning models using clustered historical sensor data according to the present disclosure. Historical datasets derived from seismic sensors 102 and non-seismic sensors 104 are first fused and then clustered or aggregated by geographic site to form discrete training corpora per location. For each cluster, a spatio-temporal model is trained and evaluated, and, upon satisfactory performance, the corresponding model architecture and learned weights are stored in models'repository 222 for localized deployment, comparative analysis, and future updating. This site-focused workflow complements the system-level “super” model training described with respect to FIG. 2 and supports tailored inference in the process 100 of FIG. 1

According to an example implementation, at step 302, the method 300 includes aggregating historical datasets collected from the seismic sensors 102 and the non-seismic sensors 104. This function can be performed by a data-ingest and curation subsystem executing on one or more processors that retrieve time-stamped measurements, site metadata 101, and any ground-truth labels from storage systems, including a historical decisions database 122 referenced in FIG. 1. In a broad aspect, aggregating historical datasets consolidates heterogeneous records, such as seismic waveforms, non-seismic telemetry, device health indicators, and event labels, into a consistent schema. For example, this may be performed so that downstream fusion, clustering, and training operate on complete, comparable inputs across sources and time periods.

At block 304, the method 300 includes fusing the aggregated datasets to form a unified training set. This function can be performed by a data fusion component 230 running on one or more processors to align timestamps, normalize units, handle missingness, and construct synchronized examples that combine seismic and non-seismic measurements. In a broad aspect, fusing the data produces modality-consistent, time-aligned inputs that expose cross-modal dependencies and spatio-temporal patterns. For example, this may be performed to reduce information loss from differing cadences and to enable models to learn relationships that manifest only when modalities are considered jointly.

At block 306, the method 300 includes clustering or aggregating sensors by geographic site to produce site-specific training groups. This function can be performed by a clustering component 332 that uses site coordinates, operational boundaries, or other spatial criteria to assign fused records to clusters corresponding to distinct monitoring locations or regions. In a broad aspect, clustering by site isolates local context, such as environmental conditions, instrumentation profiles, and management practices, so each site-specific dataset reflects its own baseline and variability. For example, this may be performed to improve model fit to local distributions and to reduce confounding from geographically distant patterns.

At block 308, the method 300 includes training a spatio-temporal machine-learning model for each site-specific cluster. This function can be performed by a training module 240 executing on processors and, where applicable, accelerators to optimize model parameters using the site's fused training data and any associated metadata. In a broad aspect, training per-site models tailors representations to local signal characteristics while retaining general spatio-temporal structure learned from the fused inputs. For example, this may be performed to enhance prediction quality for each location, especially where local noise profiles or behavior differ from broader regional trends.

At block 310, the method 300 includes evaluating each trained site-specific model to assess prediction quality and performance consistency within its cluster. This function can be performed by an evaluation component 250 that applies validation protocols, such as time-split and geography-split tests, and assesses metrics relevant to discrimination, calibration, lead time, and stability. In a broad aspect, evaluating the site-specific models quantifies whether each model meets operational criteria for its location and identifies cases where additional training, tuning, or data curation may be required. For example, this may be performed to ensure dependable deployment in the real-time workflow 100.

At step 312, the method 300 includes storing, for each validated site-specific model, a model architecture and corresponding learned weights in a models'repository 222. This function can be performed by a model registry service 260 that persists model artifacts, training metadata, and version identifiers to storage for controlled rollout and future updates. In a broad aspect, storing the model artifacts with provenance enables reproducible deployment, auditability, rollback, and comparative analysis among versions. For example, this may be performed to support localized inference, targeted retraining when new data arrive, and coordinated maintenance of model fleets across sites.

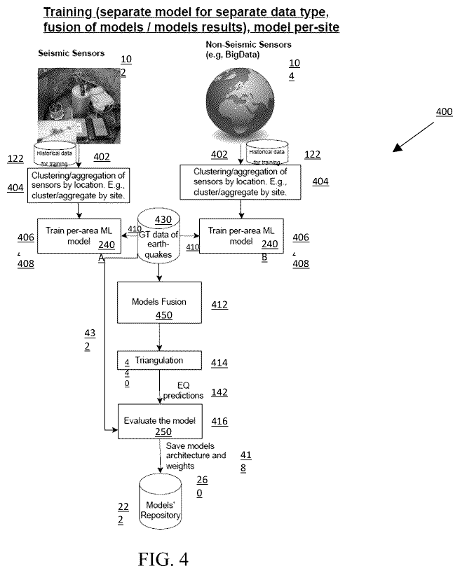

Referring to FIG. 4, a training process 400 is shown for generating fused, site-specific machine-learning models from heterogeneous sensor types according to the present disclosure. For example, historical datasets obtained from seismic sensors 102 and non-seismic sensors 104 are grouped by monitoring site 101 and used to train respective per-area models for each data type. Outputs or internal representations from the separately trained seismic-based and non-seismic-based models are combined by a model-fusion component and subjected to triangulation to enhance spatial localization, producing earthquake-prediction results suitable for evaluation. Upon satisfactory performance, corresponding model architectures and learned parameter weights are stored in a models'repository 222 for deployment, lifecycle management, and future retraining.

According to an example implementation, steps 402, the method 400 includes aggregating historical datasets, such as datasets 122, obtained from the seismic sensors 102 and the non-seismic sensors 104. In an example, this function can be performed by a data-ingest and curation subsystem executing on one or more processors to retrieve time-stamped measurements, metadata, and labels associated with sites 101 and prior decision outcomes as described with respect to processes 100-300. In a broad aspect, aggregating historical datasets consolidates heterogeneous records, such as seismic waveforms, non-seismic telemetry, device health indicators, and event labels, into a consistent schema to support downstream separation by data type, clustering by site, and model training.

At blocks 404, the method 400 includes clustering or aggregating the historical datasets by geographic location to form site-specific groups. This function can be performed by a clustering component operating on one or more processors to assign sensor records to site-level groups based on coordinates, operational boundaries, or other spatial criteria. In a broad aspect, clustering by site isolates local environmental and operational context so that each group reflects its own baseline, variability, and instrumentation profile, which improves the suitability of per-area models for localized prediction tasks.

At blocks 406, the method 400 includes training a per-area machine-learning model using the seismic sensor data for a given site-specific group. This function can be performed by a training module, such as training module 240A (seismic sensors 102) that executes on processors and, where applicable, accelerators to optimize model parameters with respect to earthquake-prediction targets using the site's seismic historical data. In a broad aspect, training the seismic-based per-area model tailors the learned representation to the spectral and temporal characteristics of ground-motion signals at the site, capturing local noise conditions and station-specific responses.

At blocks 408, the method 400 includes training a per-area machine-learning model using the non-seismic sensor data for the same site-specific group. This function can be performed by training module 240B (non-seismic sensors 104) operating on one or more processors to learn patterns from non-seismic telemetry, including environmental, infrastructure, or biological measurements associated with the site 101. In a broad aspect, training the non-seismic-based per-area model captures complementary information that may precede or correlate with seismic activity, providing an additional predictive pathway that remains available when seismic data are sparse or noisy.

At step 410, the method 400 includes incorporating ground-truth earthquake data to supervise the training of the separate models. This function can be performed by a labeling and supervision component 430 that aligns event catalogs, magnitudes, and timing information with site-specific historical records to form training targets. In a broad aspect, incorporating ground-truth data anchors the learning process to verified outcomes, enabling discriminative training for likelihood, timing, or magnitude-related targets and supporting calibrated predictions. As shown in FIG. 4, process 400 may then proceed directly to evaluating the model at block 416 at step 432, or proceed to block 412.

At block 412, the method 400 includes fusing outputs or internal representations from the seismic-based and non-seismic-based per-area models to generate a unified fused model. This function can be performed by a model-fusion component 450 executing on one or more processors to combine logits, probabilities, feature embeddings, or other intermediate signals into a joint representation. In a broad aspect, fusing model information leverages complementary modalities to improve robustness and stability, allowing the unified fused model to benefit from signals that may be weak or intermittent in any single data type.

At block 414, the method 400 includes applying triangulation to the fused model outputs to enhance location accuracy and generate earthquake-prediction results. This function can be performed by a spatial analysis component 440 that combines site-level predictions across neighboring sites 101 to refine spatial localization. In a broad aspect, triangulation synthesizes geographically distributed predictions to produce spatially coherent results, reducing ambiguity in epicentral zone estimation and improving actionable localization.

At block 416, the method 400 includes evaluating the fused and triangulated model for accuracy and performance. This function can be performed by an evaluation component 250 that executes validation protocols, such as temporally or geographically separated testing, and assesses metrics related to discrimination, calibration, lead-time characteristics, and stability. In a broad aspect, evaluating the fused and triangulated model verifies suitability for operational use, identifies opportunities for tuning, and confirms that multi-modal fusion and spatial reasoning provide measurable improvements. As shown in FIG. 4, this may include outputting an earthquake-prediction result 142, which may be used to evaluate the trained model.

At block 418, the method 400 includes storing a model architecture and corresponding learned weights associated with the validated fused model in the models repository 222. This function can be performed by a model registry service 260 that persists model artifacts, training metadata, and version identifiers to storage to support deployment and lifecycle management. In a broad aspect, storing the model artifacts with provenance enables reproducible rollout, auditability, rollback, and comparative analysis across versions, facilitating ongoing maintenance and selective updates as additional training data become available.

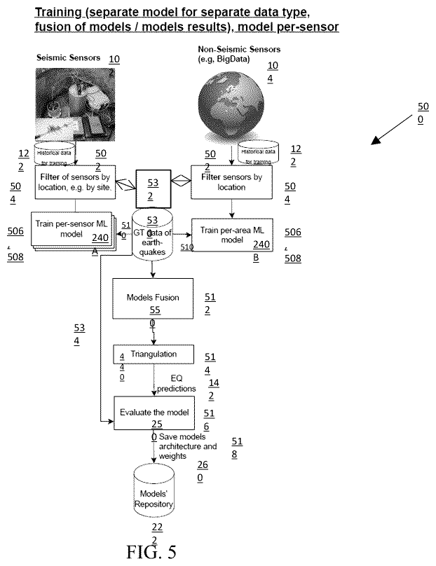

Referring to FIG. 5, a process 500 is shown for training separate per-sensor machine-learning models for different data types and generating fused, triangulated earthquake-prediction outputs according to the present disclosure. In an example, historical datasets from seismic sensors 102 and non-seismic sensors 104 are filtered based on location to identify sensors associated with particular sites 101 or regions. For each filtered sensor, a per-sensor machine-learning model is trained under supervision using ground-truth earthquake data. Outputs or intermediate representations from the separately trained seismic-based and non-seismic-based per-sensor models are combined by a model-fusion component and subjected to triangulation to improve spatial localization. Predicted outputs are evaluated, and, when performance satisfies operational criteria, corresponding model architectures and learned parameter weights are stored in a models repository 222 for later deployment, comparison, and refinement. According to an aspect, this fine-grained, sensor-level pipeline of process 500 may complement the site-level and super-model training workflows described in FIGS. 3 and 2 and supplies models for use in the inference and alert-generation workflow 100 of FIG. 1.

According to an example implementation, at steps 502, the method 500 includes aggregating historical datasets 122 obtained from the seismic sensors 102 and the non-seismic sensors 104. This function can be performed by a data-ingest and curation subsystem 530 executing on one or more processors that retrieve time-stamped measurements, site metadata 101, and prior decision outcomes (e.g., from a historical decisions database 122 associated with workflow 100 of FIG. 1). In a broad aspect, aggregating historical datasets consolidates heterogeneous records, including seismic waveforms, non-seismic telemetry, device diagnostics, and event labels, into a consistent schema. In an example, this may be performed so that downstream filtering, training, fusion, and evaluation operate on complete, comparable inputs across sources and time periods.

At blocks 504, the method 500 includes performing location-based filtering of the aggregated datasets to select sensors associated with a particular monitoring site or region. This function can be performed by a filtering component 530 running on one or more processors to assign sensor records to filtered groups using coordinates, operational boundaries, or other spatial criteria. In a broad aspect, location-based filtering isolates sensor-specific histories within defined spatial contexts so that each per-sensor model learns from data reflecting the sensor's operating environment, baseline behavior, and local noise profile.

At blocks 506, the method 500 includes training a per-sensor machine-learning model using seismic sensor data. This function can be performed by a training module 240A (seismic sensors 102) executing on processors and, where applicable, accelerators to optimize model parameters with respect to earthquake-prediction targets using the filtered seismic history for a given sensor 102. In a broad aspect, training the seismic-based per-sensor model tailors representations to the spectral and temporal characteristics of the individual sensor's ground-motion measurements, improving sensitivity to changes observed by that specific instrument.

At blocks 508, the method 500 includes training a per-sensor machine-learning model using non-seismic sensor data. This function can be performed by the training module 240B (non-seismic sensors 104) operating on one or more processors to learn patterns from the filtered non-seismic telemetry associated with a given sensor 104. In a broad aspect, training the non-seismic-based per-sensor model captures complementary signals that may precede or correlate with seismic activity, providing an additional predictive pathway that remains available when seismic data are sparse or noisy.

At step 510, the method 500 includes incorporating ground-truth earthquake data to supervise the training of the per-sensor models. This function can be performed by a supervision component 530 that aligns event catalogs, magnitudes, and timing information to form labels for the filtered per-sensor histories. In a broad aspect, incorporating ground-truth anchors the learning process to verified outcomes so that model outputs, such as likelihoods, timing estimates, or magnitude-related signals, are calibrated to known events. As shown in FIG. 5, process 500 may then proceed directly to evaluating the model at block 516 at step 534, or proceed to block 512.

At block 512, the method 500 includes fusing the separately trained per-sensor seismic and non-seismic predictive models. This function can be performed by a model-fusion component 550 executing on one or more processors to combine outputs or internal representations (e.g., logits, probabilities, or feature embeddings) from the per-sensor models into a joint fused representation. In a broad aspect, fusing per-sensor model information leverages complementary modalities at the finest granularity, increasing robustness to transient noise in any single sensor and improving the stability of predictions derived from heterogeneous sources.

At block 514, the method 500 includes performing triangulation on the fused model outputs to enhance localization accuracy and produce earthquake-prediction results. This function can be performed by a triangulation component 440 that synthesizes fused outputs from multiple sensors (and optionally multiple nearby sites 101) to refine epicentral zone estimates. In a broad aspect, triangulation applies spatial reasoning to reconcile geographically distributed signals, reducing ambiguity in location and improving the actionability of predictions for downstream alerting.

At block 516, the method 500 includes evaluating the fused and triangulated outputs for accuracy and performance. This function can be performed by an evaluation module 250 that conducts temporally and geographically separated validation and assesses metrics related to discrimination, calibration, lead-time distributions, and stability under distributional shifts. Additional evaluation approaches can follow those described for processes 200-400 in FIGS. 2-4. In a broad aspect, evaluating the fused and triangulated outputs verifies suitability for operational use, identifies opportunities for tuning, and confirms that per-sensor modeling combined with fusion and triangulation provides measurable improvements.

At step 518, the method 500 includes storing a model architecture and corresponding learned weights in a models repository 222. This function can be performed by model registry service 260 that persists model artifacts, training metadata, and version identifiers to storage for controlled deployment to process 100 of FIG. 1 and for lifecycle management. In a broad aspect, storing model artifacts with provenance enables reproducible rollout, auditability, rollback, and comparative analysis across versions, facilitating targeted updates as additional training data are acquired or as sensor conditions evolve.

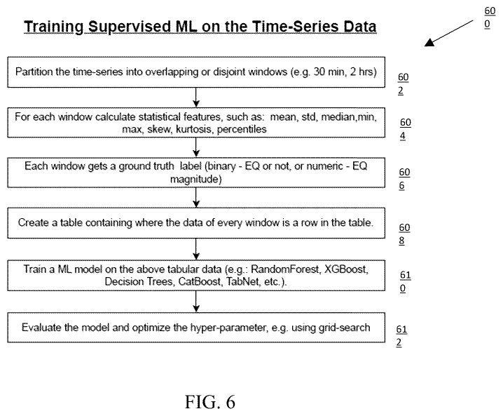

Referring to FIG. 6, a process 600 is shown for training a supervised machine-learning model on time-series sensor data according to the present disclosure. The process transforms raw time-indexed measurements from seismic sensors 102 and non-seismic sensors 104 into tabular feature vectors aligned with ground-truth labels, trains a predictive model using the resulting table, and evaluates and tunes the model for earthquake-related classification or regression tasks. This offline feature-engineering and training workflow complements the real-time inference workflow 100 of FIG. 1 and may be used to produce models for use in the site-level and sensor-level pipelines described with respect to FIGS. 3-5.

At block 602, the method 600 includes partitioning a time-series dataset 628 into a sequence of overlapping or non-overlapping temporal windows. This function can be performed by a windowing component 630 executing on one or more processors of a device or networked computing environment, which segments continuous measurements (e.g., from sensors 102, 104) into fixed-duration windows such as 30 minutes or 2 hours, optionally with a configurable stride stored as window configuration metadata 629. In a broad aspect, partitioning the dataset 628 into windows creates comparable analysis units that preserve local temporal structure while standardizing the input length for downstream feature extraction and modeling.

At block 604, the method 600 includes computing, for each window, a set of statistical features. This function can be performed by a feature computation component 632 executed by one or more processors to derive statistics such as mean, standard deviation, median, minimum, maximum, skewness, kurtosis, and percentile values for each signal channel within the window; additional feature families (e.g., spectral or temporal descriptors) may also be computed consistent with related training workflows. In a broad aspect, computing statistical features summarizes each window into a compact vector that captures central tendency, dispersion, shape, and extreme values, enabling efficient learning by tabular machine-learning models.

At block 606, the method 600 includes assigning a ground-truth label to each windowed segment. This function can be performed by a labeling component 634 that aligns window timestamps to an event catalog 626 to assign labels such as a binary indicator of whether an earthquake event occurred or a numerical value corresponding to earthquake magnitude or another target. In a broad aspect, assigning labels anchors each feature vector to a known outcome, enabling supervised learning for classification or regression objectives tailored to operational prediction needs.

At block 608, the method 600 includes storing the feature vectors and corresponding labels in a tabular dataset 638 in which each window constitutes a row. This function can be performed by a dataset assembly component 636 that writes rows comprising window identifiers, computed features, and labels to a training table 638 in memory or persistent storage for later retrieval by a training module. In a broad aspect, assembling a tabular dataset 638 standardizes access for model training and evaluation, supports reproducibility, and facilitates downstream operations such as shuffling, batching, and cross-validation.

At block 610, the method 600 includes training a supervised machine-learning model on the table of features and labels. This function can be performed by a training module 640 executed on processors and, where applicable, accelerators to fit model parameters for models such as RandomForest, XGBoost, decision trees, CatBoost, or TabNet using the tabular dataset 638, producing a trained supervised model 642. In a broad aspect, training a supervised model learns mappings from feature vectors to targets, producing a predictive function that generalizes to unseen windows for earthquake-related likelihoods, magnitudes, or other outputs.

At block 612, the method 600 includes evaluating the trained supervised model 642 and performing hyperparameter optimization. This function can be performed by an evaluation and tuning component 650 that assesses predictive performance using validation procedures and tunes hyperparameters via a hyperparameter optimization subcomponent 652 (e.g., grid search, randomized search, or Bayesian optimization) to improve accuracy, calibration, and stability. In a broad aspect, evaluating and optimizing the model quantifies performance against selected metrics and refines model settings to enhance operational utility before the model is registered for deployment or stored in a models repository 622 for lifecycle management and future integration with workflows described in FIGS. 1-5.

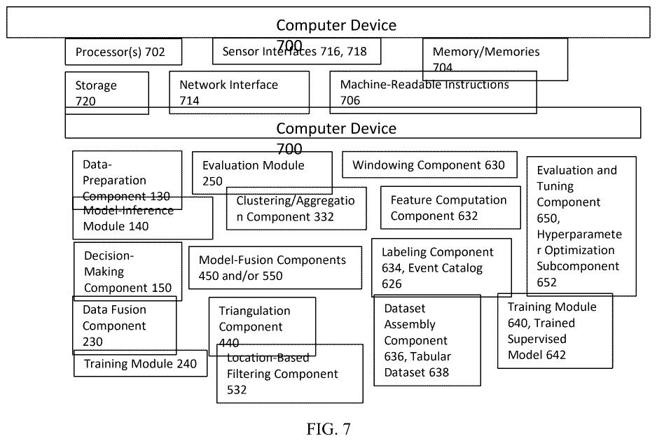

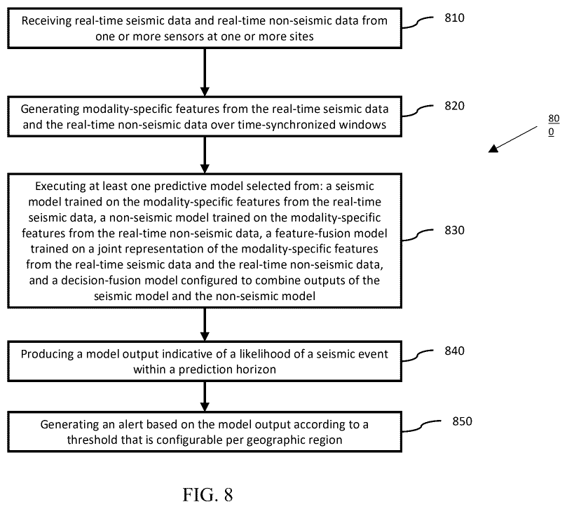

Referring to FIG. 7, in a non-limiting example, a computer device 700 is configured to implement functionalities of the present disclosure, including the real-time inference and alert-generation process 100 (FIG. 1) and offline training processes 200, 300, 400, 500, and 600 (FIGS. 2-6), as well as an example method 800 (FIG. 8). In operation, the present disclosure includes processors 702 executing machine-readable instructions 706 stored in system memory 704 to orchestrate: multi-modal data ingest from seismic sensors 102 and non-seismic sensors 104 via sensor interfaces 716, 718; transport over a data path 108; data-preparation component 130 to generate model-specific input data 132; model-inference module 140 to produce an earthquake-prediction result 142; decision-making component 150 and decision branch 160 for calibrated thresholding and alert gating; and dissemination through an alert system 170 to terminal devices and end instruments 172 (e.g., computer terminals, landline telephones, smartphones). Storage 720 provides persistent repositories, including a historical decisions database 122 and a models repository 222 accessed via a model registry service 260 for versioning and deployment. The same device 700 supports offline training: a data fusion component 230; a training module 240; an evaluation module 250; optional clustering/aggregation component 332 (site-level, FIG. 3); location-based filtering component 532 (per-sensor, FIG. 5); model-fusion components 450 and/or 550; triangulation component 440; and components of process 600, including a windowing component 630, feature computation component 632, labeling component 634 with event catalog 626, dataset assembly component 636 producing a tabular dataset 638, a training module 640 yielding a trained supervised model 642, and evaluation and tuning component 650 with hyperparameter optimization subcomponent 652. Hardware resources (processors 702, memory 704, storage 720, and network interface 714) provide compute, storage, and communication to run these components at scale and interoperate across workflows 100, 200, 300, 400, 500, and 600, enabling continuous model development, calibrated inference, regional aggregation, and alert delivery.

Referring to FIG. 8, a flowchart of an example method 800 is shown for seismic event prediction according to the present disclosure. In practice, method 800 corresponds to operations executed by a system having seismic sensors 102, non-seismic sensors 104, and one or more processors 702 with memory 704 (e.g., computer device 700 of FIG. 7) operating components such as a data-preparation component 130, a model-inference module 140, a decision-making component 150, and an alert system 170.

At block 802, the method 800 includes receiving real-time seismic data and real-time non-seismic data from the one or more sites 101. For example, in an aspect, computer device 700, processors 702, memory 704, sensor interfaces 716, 718, and/or an ingest subsystem may be configured to receive continuous streams from seismic sensors 102 and non-seismic sensors 104 over network interface 714, optionally with intake validation and metadata capture (e.g., timestamps, site identifiers, device health). Prior descriptions of inputs and site context are provided with reference to FIG. 1. For example, the receiving at block 802 may include accepting multi-modal streams, normalizing time bases (e.g., GPS, UTC), and buffering synchronized segments for downstream processing. Centralizing intake supports auditability and ensures that both modalities are available to subsequent feature extraction and model selection while maintaining association with site 101.

At block 804, the method 800 includes generating modality-specific features from the real-time seismic data and the real-time non-seismic data over time-synchronized windows. For example, in an aspect, computer device 700, processors 702, memory 704, and/or the data-preparation component 130 may be configured to window the streams (e.g., 30-minute or 2-hour windows with a configurable stride), align modalities, and compute features appropriate to each modality. For example, generating features at block 804 may compute, for seismic data, bandpower, spectral entropy, STA/LTA ratios, and autoregressive coefficients, and for non-seismic data, statistical, spectral, and temporal descriptors suited to the telemetry source. Time-synchronized windows preserve temporal correspondence across modalities, enabling consistent downstream inference.

At block 806, the method 800 includes executing at least one predictive model selected from a seismic model trained on seismic features, a non-seismic model trained on non-seismic features, a feature-fusion model trained on a joint representation of seismic and non-seismic features, and a decision-fusion model configured to combine outputs of the seismic and non-seismic models. For example, in an aspect, the model-inference module 140 may route the windowed features to a selected pathway based on operational context (e.g., sensor availability, data quality). For example, the executing at block 806 may include loading trained models from models repository 222 via model registry service 260, applying the selected pathway, and producing intermediate inferences that leverage complementary modalities when available while maintaining operation for single-modality scenarios.

At block 808, the method 800 includes producing a model output indicative of a likelihood of a seismic event within a prediction horizon. For example, in an aspect, the model-inference module 140 may output a probability, and optionally a magnitude estimate or a predicted time window, derived from the selected model's outputs. For example, producing the model output at block 808 provides an interpretable quantity for downstream decision logic, enabling threshold-based actions aligned with operational lead-time requirements.

At block 810, the method 800 includes generating an alert based on the model output according to a threshold that is configurable per geographic region. For example, in an aspect, the decision-making component 150 applies region-specific thresholds (and, in some implementations, persistence or hysteresis criteria) and, when satisfied, activates the alert system 170 to disseminate notifications to terminal devices and end instruments 172 (e.g., computer terminals, landline telephones, smartphones). For example, generating the alert at block 810 tailors notification sensitivity to regional seismicity and policy preferences, supporting reliable, calibrated alerting while controlling false alarms.

In an example implementation consistent with the foregoing workflows, the present disclosure includes two complementary datasets that differ in cadence and semantic focus: a daily dataset that characterizes animals and their context, and a 15-minute dataset that emphasizes short-horizon behavioral dynamics. At ingestion, these datasets are received together with seismic streams at sites 101 and are routed to the data-preparation component 130 (method 100, blocks 101, 108, and 804). The daily dataset supplies relatively stable attributes and coarse activity summaries that anchor long-term baselines, while the 15-minute dataset provides higher-frequency telemetry suited to detecting short-lived departures from normal behavior that may contribute to predictive signals. Windowing and feature construction are performed as described for process 600 (blocks 602-608).

The present disclosure includes a daily dataset with the following non-limiting fields: PastureID (pasture identification number), PastureLocation (pasture latitude, longitude, and optionally elevation), AnimalID (animal identification number), Age (days from birth), lactationNumber (count of completed lactation cycles), Activity (number of minutes of activity in the most active hour of the day), RestTime (minutes of rest per day), and RestBout (minutes of lying on the ground per day). In operation, the data-preparation component 130 propagates these daily fields into time-synchronized windows (method 100, block 804; process 600, block 602) for each AnimalID and PastureID, enabling per-pasture aggregation and site-level grouping using, for example, the site clustering component 332 (process 300).

The present disclosure includes a 15-minute dataset with the following non-limiting fields: AnimalID (animal identification number), CollarID (collar identification number), GroupNumber (animal's group), KineticsCountX (forward/backward cumulative absolute acceleration), KineticsCountY (vertical cumulative absolute acceleration), KineticsCountZ (lateral cumulative absolute acceleration), KineticsCountR (weighted cumulative absolute acceleration), and FrequencyVariance (variance or dispersion of neck-movement frequencies over the interval). These fields are summarized by the feature computation component 632 within each time window (process 600, block 604) and are aligned to co-temporal seismic features for downstream modeling by the model-inference module 140 (method 100, blocks 804-806).

The present disclosure includes synchronized ingestion and alignment of the daily and 15-minute datasets with seismic streams into windows (e.g., 30-minute or 2-hour windows with configurable stride) using the windowing component 630 (process 600, block 602). Daily fields are propagated to corresponding windows and aggregated to pasture-level statistics (e.g., means, quantiles, dispersion, and change-point indicators) for site-level training (process 300, blocks 306-312). Fifteen-minute fields are summarized per window (e.g., means, variances, spectral descriptors, diurnal deviation scores, and group dispersion metrics) and aligned to seismic features for inference (method 100, block 806). Quality control includes handling missingness, detecting collar changes, accounting for group reassignments, and filtering known management events; curated outputs can be logged to the historical decisions database 122 (method 100, block 118).

The present disclosure includes training pipelines operating along multiple pathways using shared services across FIGS. 2-5: non-seismic-only models using daily and 15-minute telemetry; seismic-only models using waveform-derived features; and fusion models using joint feature vectors or decision-level combinations. The data fusion component 230 prepares unified training sets (process 200, block 204); the training module 240 learns spatio-temporal “super” models (process 200, block 206) and site-specific models (process 300, block 308); and the evaluation module 250 validates performance (processes 200, 300, 400, 500). Separate per-type training (process 400, blocks 406-412) and per-sensor training with location-based filtering (process 500, blocks 504-512) can be fused by model-fusion components 412 and/or 552 and spatially triangulated by component 556 prior to aggregation (method 100, block 112) and alert decisioning (method 100, blocks 114-116). Trained artifacts are versioned and deployed via the model registry service 260 to the models repository 222 (processes 200, 210; 300, 312; 400, 418; 500, 518).

According to another aspect, labels can include binary event likelihood within a lead-time window, magnitude ranges, or time-to-event targets derived from event catalogs (process 600, block 606, event catalog 626). The tabular training dataset 638 assembled by component 636 supports supervised learners (process 600, block 610) and evaluation/tuning (component 650, block 612). The daily dataset contributes slowly varying covariates and stable pasture/animal descriptors that improve baseline modeling in site-specific training (process 300), while the 15-minute dataset contributes short-horizon behavioral signals aligned to seismic windows that are leveraged in fusion pathways (method 100, block 806; processes 400, 500).

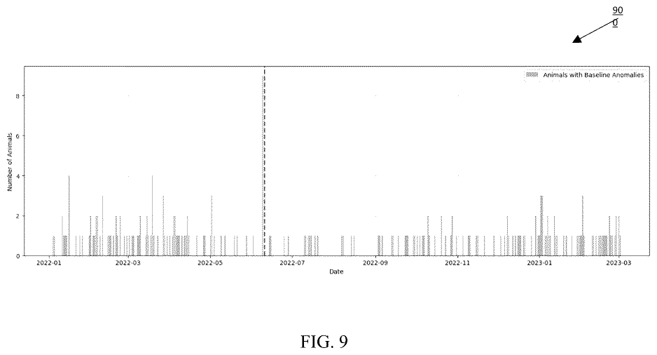

As a non-limiting empirical illustration, FIG. 9 details graph 900 of an example implementation: “Pasture 24088—Daily Count of Animals with Baseline Anomalies.” According to the example depicted in graph 900, over a two-year sensor period, a significant earthquake occurred in Cyprus on Jun. 10, 2022. Sensors were deployed approximately 30 km from the epicenter, and the behavioral telemetry exhibited a pronounced anomaly (score near 9) approximately 24 hours prior to the event. This observation can be represented in the evaluation module 250 as a case study, logged in the database 122 (method 100, block 118), and used to inform calibration thresholds (method 100, block 114) and ablation analyses comparing seismic-only, non-seismic-only, and fusion pathways. The figure serves as a placeholder and may be updated with improved resolution and labeling.

According to an aspect, the present disclosure addresses limitations of single-modality approaches by processing heterogeneous sensor data to provide earlier and more reliable seismic event predictions. Conventional earthquake early warning operates after rupture begins and is constrained to seconds-to-tens-of-seconds lead time. By contrast, the present disclosure includes multi-modal sensing, seismic sensors 102 and non-seismic sensors 104, time-synchronized feature extraction, and model pathways that exploit complementary signals, enabling calibrated alerts suitable for operational use.

Historical and real-time datasets may include seismic waveforms, environmental and infrastructure telemetry, and, in some aspects, biological telemetry. These heterogeneous inputs are aligned into windows, transformed into modality-specific and fused features, and processed by seismic-only, non-seismic-only, and fusion models. Aggregation across sites 101, triangulation, and region-specific thresholds support spatial coherence and controlled false-alarm rates. This framework focuses on statistically and operationally validated indicators without requiring direct stress-field estimation.

According to an example implementation, a computing environment such as computer device 700 (FIG. 7) executes these workflows. The computing device 700 includes one or more processors 702, memory 704 storing instructions 706, storage 720, and network interface 714. Sensor interfaces 716, 718 receive data streams from seismic sensors 102 and non-seismic sensors 104. Processors 702 execute components including a data-preparation component 130, model-inference module 140, decision-making component 150 with decision branch 160, and alert system 170 interfacing with terminal devices and end instruments 172.

According to another aspect, offline training and lifecycle management are supported by shared services reused across workflows: a data fusion component 230, a training module 240, and an evaluation module 250. Trained artifacts are versioned and deployed via a model registry service 260 to a models repository 222. Workflow-specific components may include site clustering 332, location-based filtering 532, model-fusion components 450 and/or 550, triangulation 440, and supervised tabular training components 630-652 (FIG. 6).

According to another aspect, process execution can be distributed across on-premises and cloud resources. Processors 702 can include general-purpose CPUs and accelerators (e.g., GPUs) suitable for time-series feature extraction, model training, and low-latency inference. Storage 720 persists input data, features, model artifacts, and decision logs; the models repository 222 maintains architectures, learned weights, and metadata for auditability and rollback. The network interface 714 supports ingestion from remote sites 101 and dissemination of alerts through alert system 170.

Software components may be implemented as executable instructions stored in memory 704 and executed by processors 702, while hardware embodiments may realize portions of the pipeline using dedicated logic. Components can be combined, partitioned, or replicated to meet throughput and resiliency requirements. The same logical services (e.g., data fusion component 230, training module 240, evaluation module 250, model registry service 260, models repository 222) can be referenced with the same identifiers across figures when they represent shared system services.

Variations within the present disclosure include alternative feature families (statistical, spectral, temporal), alternative model classes (tree-based, neural, hybrid, physics-informed), and alternative fusion strategies (feature-level, decision-level). Thresholds can be calibrated per region using historical catalogs, and alert policies can incorporate persistence or hysteresis to stabilize notifications. Aggregation may include statistical methods, learned combiners, or triangulation to improve spatial localization.

The method and system can be implemented as software-and hardware-based tools that analyze seismic data to map stress fields before and during earthquakes, and include real-time monitoring using seismic sensors 102 and/or non-seismic sensors 104, leveraging machine learning to identify patterns preceding earthquakes. Other hardware components and devices can interface with the computing device. A controller can be part of the computer system that executes programming for controlling the system for analyzing seismic data differently from conventional methods to map stress fields before and during earthquakes, and include real-time monitoring using non-seismic sensors, leveraging machine learning to identify patterns preceding earthquakes, as described herein. The computing system can be implemented as or can include a computing device that includes a combination of hardware, software, and firmware that allows the computing device to run an applications layer or otherwise perform various processing tasks. Computing devices can include without limitation personal computers, work stations, servers, laptop computers, tablet computers, mobile devices, hand-held devices, wireless devices, smartphones, wearable devices, embedded devices, microprocessor-based devices, microcontroller-based devices, programmable consumer electronics, mini-computers, main frame computers, and the like.

The computing device 700 can include a basic input/output system (BIOS) and an operating system as software to manage hardware components, coordinate the interface between hardware and software, and manage basic operations such as start up. The computing device can include one or more processors and memory that cooperate with the operating system to provide basic functionality for the computing device. The operating system provides support functionality for the applications layer and other processing tasks. The computing device can include a system bus or other bus (such as memory bus, local bus, peripheral bus, and the like) for providing communication between the various hardware, software, and firmware components and with any external devices. Any type of architecture or infrastructure that allows the components to communicate and interact with each other can be used.

Processing tasks can be carried out by one or more processors 702. Various types of processing technology can be used, including a single processor or multiple processors, a central processing unit (CPU), multicore processors, parallel processors, or distributed processors. Additional specialized processing resources such as graphics (e.g., a graphics processing unit or GPU), video, multimedia, or mathematical processing capabilities can be provided to perform certain processing tasks. Processing tasks can be implemented with computer-executable instructions, such as application programs or other program modules, executed by the computing device. Application programs and program modules can include routines, subroutines, programs, scripts, drivers, objects, components, data structures, and the like that perform particular tasks or operate on data.

Processors 702 can include one or more logic devices, such as small-scale integrated circuits, programmable logic arrays, programmable logic devices, masked-programmed gate arrays, field programmable gate arrays (FPGAs), application specific integrated circuits (ASICs), and complex programmable logic devices (CPLDs). Logic devices can include, without limitation, arithmetic logic blocks and operators, registers, finite state machines, multiplexers, accumulators, comparators, counters, look-up tables, gates, latches, flip-flops, input and output ports, carry in and carry out ports, and parity generators, and interconnection resources for logic blocks, logic units and logic cells.

The computing device 700 includes memory 704 or storage 720, which can be accessed by the system bus or in any other manner. Memory can store control logic, instructions, and/or data. Memory can include transitory memory, such as cache memory, random access memory (RAM), static random access memory (SRAM), main memory, dynamic random access memory (DRAM), block random access memory (BRAM), and memristor memory cells. Memory can include storage for firmware or microcode, such as programmable read only memory (PROM) and erasable programmable read only memory (EPROM). Memory can include non-transitory or nonvolatile or persistent memory such as read only memory (ROM), one time programmable non-volatile memory (OTPNVM), hard disk drives, optical storage devices, compact disc drives, flash drives, floppy disk drives, magnetic tape drives, memory chips, and memristor memory cells. Non-transitory memory can be provided on a removable storage device. A computer-readable medium can include any physical medium that is capable of encoding instructions and/or storing data that can be subsequently used by a processor to implement embodiments of the method and system described herein. Physical media can include floppy discs, optical discs, CDs, mini-CDs, DVDs, HD-DVDs, Blu-ray discs, hard drives, tape drives, flash memory, or memory chips. Any other type of tangible, non-transitory storage that can provide instructions and/or data to a processor can be used in these embodiments.

The computing device 700 can include one or more input/output interfaces for connecting input and output devices to various other components of the computing device. Input and output devices can include, without limitation, keyboards, mice, joysticks, microphones, cameras, webcams, displays, touchscreens, monitors, scanners, speakers, and printers. Interfaces can include universal serial bus (USB) ports, serial ports, parallel ports, game ports, and the like.

The computing device 700 can access a network over a network connection that provides the computing device with telecommunications capabilities. Network connection enables the computing device to communicate and interact with any combination of remote devices, remote networks, and remote entities via a communications link. The communications link can be any type of communication link, including without limitation a wired or wireless link. For example, the network connection can allow the computing device to communicate with remote devices over a network, which can be a wired and/or a wireless network, and which can include any combination of intranet, local area networks (LANs), enterprise-wide networks, medium area networks, wide area networks (WANs), the Internet, cellular networks, and the like. Control logic and/or data can be transmitted to and from the computing device via the network connection. The network connection can include a modem, a network interface (such as an Ethernet card), a communication port, a PCMCIA slot and card, or the like to enable transmission of and receipt of data via the communications link.

The computing device 700 can include a browser and a display that allow a user to browse and view pages or other content served by a web server over the communications link. A web server, server, and database can be located at the same or at different locations and can be part of the same computing device, different computing devices, or distributed across a network. A data center can be located at a remote location and accessed by the computing device over a network.

The computer system can include architecture distributed over one or more networks, such as, for example, a cloud computing architecture. Cloud computing includes without limitation distributed network architectures for providing, for example, software as a service (SaaS), infrastructure as a service (IaaS), platform as a service (PaaS), network as a service (NaaS), data as a service (DaaS), database as a service (DBaaS), desktop as a service (DaaS), backend as a service (BaaS), test environment as a service (TEaaS), API as a service (APIaaS), and integration platform as a service (IPaaS).

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

As used herein, “consisting essentially of” allows the inclusion of materials or steps that do not materially affect the basic and novel characteristics of the claim. Any recitation herein of the term “comprising,” particularly in a description of components of a composition or in a description of elements of a device, can be exchanged with “consisting essentially of” or “consisting of.”

It will be appreciated that the various features of the embodiments described herein can be combined in a variety of ways. For example, a feature described in conjunction with one embodiment may be included in another embodiment even if not explicitly described in conjunction with that embodiment.

To the extent that the appended claims have been drafted without multiple dependencies, this has been done only to accommodate formal requirements in jurisdictions which do not allow such multiple dependencies. It should be noted that all possible combinations of features which would be implied by rendering the claims multiply dependent are explicitly envisaged and should be considered part of the invention.

The present invention has been described in conjunction with certain preferred embodiments. It is to be understood that the invention is not limited to the exact details of construction, operation, exact materials or embodiments shown and described, and that various modifications, substitutions of equivalents, alterations to the compositions, and other changes to the embodiments disclosed herein will be apparent to one of skill in the art.

What is claimed is:

1. A system for seismic event prediction, comprising:
one or more seismic sensors configured to collect real-time seismic data at one or more sites;
one or more non-seismic sensors configured to collect real-time non-seismic data at the one or more sites; and
one or more processors and memory storing instructions that, when executed by the one or more processors, cause the system to:
receive the real-time seismic data and the real-time non-seismic data from the one or more sites;
generate modality-specific features from the real-time seismic data and the real-time non-seismic data over time-synchronized windows;
execute at least one predictive model selected from: a seismic model trained on the modality-specific features from the real-time seismic data, a non-seismic model trained on the modality-specific features from the real-time non-seismic data, a feature-fusion model trained on a joint representation of the modality-specific features from the real-time seismic data and the real-time non-seismic data, and a decision-fusion model configured to combine outputs of the seismic model and the non-seismic model;
produce a model output indicative of a likelihood of a seismic event within a prediction horizon; and
generate an alert based on the model output according to a threshold that is configurable per geographic region.

2. The system of claim 1, wherein the one or more non-seismic sensors comprise animal-wearable devices configured to capture behavioral telemetry and wherein the modality-specific features from the real-time non-seismic data comprise activity measures, rest measures, or motion-frequency variance derived from accelerometry.

3. The system of claim 1, wherein the one or more sites comprise a plurality of pastures and the one or more processors are further configured to aggregate per-animal or per-device predictions to produce per-pasture predictions and to combine the per-pasture predictions into a regional prediction.

4. The system of claim 1, wherein the one or more processors are further configured to train a spatio-temporal super model using historical seismic data and historical non-seismic data collected from the one or more sites and to adapt the spatio-temporal super model to a particular site using site-specific data.

5. The system of claim 1, wherein the one or more processors are further configured to obtain site-specific predictions from site-specific models and to combine the site-specific predictions using at least one of triangulation, statistical aggregation, or a learned aggregation model to produce the model output.

6. The system of claim 1, wherein the one or more processors are further configured to calibrate the model output to a probability using calibration data and to set the threshold based on a seismicity baseline of a geographic region.

7. The system of claim 1, wherein the one or more processors are further configured to apply hysteresis or persistence criteria to the model output prior to generating the alert.

8. The system of claim 1, wherein the one or more processors are further configured to operate in a seismic-only mode when the real-time non-seismic data are unavailable and to operate in a non-seismic-only mode when the real-time seismic data are unavailable.

9. The system of claim 1, wherein generating the modality-specific features from the real-time seismic data comprises computing bandpower features, spectral entropy, short-term-average to long-term-average ratios, or autoregressive coefficients over the time-synchronized windows.

10. The system of claim 1, wherein generating the modality-specific features from the real-time non-seismic data comprises extracting statistical features, spectral features, temporal features, or change-point indicators over the time-synchronized windows.

11. A method for seismic event prediction, comprising:
receiving real-time seismic data and real-time non-seismic data from one or more sensors at one or more sites;
generating modality-specific features from the real-time seismic data and the real-time non-seismic data over time-synchronized windows;
executing at least one predictive model selected from: a seismic model trained on the modality-specific features from the real-time seismic data, a non-seismic model trained on the modality-specific features from the real-time non-seismic data, a feature-fusion model trained on a joint representation of the modality-specific features from the real-time seismic data and the real-time non-seismic data, and a decision-fusion model configured to combine outputs of the seismic model and the non-seismic model;
producing a model output indicative of a likelihood of a seismic event within a prediction horizon; and
generating an alert based on the model output according to a threshold that is configurable per geographic region.

12. The method of claim 11, wherein the real-time non-seismic data comprise behavioral telemetry captured by animal-wearable devices and wherein generating the modality-specific features from the real-time non-seismic data comprises extracting activity measures, rest measures, or motion-frequency variance derived from accelerometry.

13. The method of claim 11, wherein the one or more sites comprise a plurality of pastures and further comprising aggregating per-animal or per-device predictions to produce per-pasture predictions and combining the per-pasture predictions into a regional prediction.

14. The method of claim 11, further comprising training a spatio-temporal super model using historical seismic data and historical non-seismic data collected from the one or more sites and adapting the spatio-temporal super model to a particular site using site-specific data.

15. The method of claim 11, further comprising obtaining site-specific predictions from site-specific models and combining the site-specific predictions using at least one of triangulation, statistical aggregation, or a learned aggregation model to produce the model output.

16. The method of claim 11, further comprising calibrating the model output to a probability using calibration data and setting the threshold based on a seismicity baseline of a geographic region.

17. The method of claim 11, further comprising localizing an epicentral zone based on spatial consistency of the per-pasture predictions.

18. The method of claim 11, further comprising selecting a predictive model based on sensor availability or data quality metrics associated with the real-time seismic data or the real-time non-seismic data.

19. The method of claim 11, wherein the prediction horizon is a lead-time window within a range from minutes to days.

20. An apparatus for seismic event prediction, comprising:
a processor;
a memory coupled to the processor;
at least one seismic sensor interface configured to receive seismic data;
at least one non-seismic sensor interface configured to receive non-seismic data; and
instructions stored in the memory that, when executed by the processor, cause the apparatus to:
time-align the seismic data and the non-seismic data into windows;
compute features from the windows;
apply a predictive model to the features to generate a score indicative of a seismic event within a lead-time window; and
compare the score to a threshold to produce an alert.
